(19) United States
(12) Patent Application Publication
(10) Pub. No.: US 2017/0215618 A1
(43) Pub. Date: Aug. 3, 2017

(54) SAFETY CUSHION MAT AND MANUFACTURING MOLD THEREFOR

(71) Applicant: TreeLine Co., Ltd., Seongnam-si (KR)

(72) Inventors: Bong Yong PARK, Seongnam-si (KR); Hyun Ki SONG, Yongin-si (KR); Seok Ho LEE, Gimpo-si (KR)

(21) Appl. No.: 15/389,406

(22) Filed: Dec. 22, 2016

(30) Foreign Application Priority Data
Feb. 2, 2016 (KR) 10-2016-0012685

(51) Int. Cl. A47G 27/02; E04F 15/02; E04F 15/10; B32B 5/18; B29C 43/36; B32B 27/06; B32B 27/08; B32B 27/32; B29C 43/20; A47D 15/00; B32B 3/26

(52) U.S. Cl. CPC A47G 27/0212; A47D 15/003; A47G 27/0275; E04F 15/02177; E04F 15/107; B32B 5/18; B32B 3/266; B32B 27/065; B32B 27/08; B32B 27/32; B29C 43/206; B29C 43/36; B29K 2023/06; B32B 2471/04; B29L 2031/7324

(57) ABSTRACT

An embodiment of the invention provides a safety cushion mat that includes an inner filler made of a synthetic resin expanded foam member, and a first sheet and a second sheet which cover an upper and a lower surface of the inner filler, respectively. The inner filler may have air outlets formed in its upper and lower surfaces in a particular pattern. The first sheet may include a first sheet body portion and a first edge portion, and the second sheet may include a second sheet body portion and a second edge portion. The second edge portion may be fused with the first edge portion of the first sheet. When the first sheet and the second sheet are fused onto both sides of the inner filler, any air remaining between the first and second sheets and the inner filler may be discharged through the air outlets of the inner filler.

### CROSS-REFERENCE TO RELATED APPLICATIONS

This application claims the benefit of Korean Patent Application No. 10-2016-0012685, filed with the Korean Intellectual Property Office on Feb. 2, 2016, the disclosure of which is incorporated herein by reference in its entirety.

### BACKGROUND

1. Technical Field

The present invention relates to a safety cushion mat and a mold for manufacturing the safety cushion mat. More particularly, the invention relates to safety cushion mat and a mold for manufacturing the safety cushion mat, which does not discharge endocrine disruptors or the like.

2. Description of the Related Art

A playroom or a home in which children often run about generally has a mat placed on the floor to protect the children from falls as well as to provide soundproofing. This type of mat may include a cushion material within and an outer skin enveloping the cushion material without.

According to the related art, however, manufacturing a mat involves molding the cushion material and outer skin from PVC and attaching the two elements with adhesive. As large amounts of endocrine disruptors such as dioxins and volatile organic compounds, produced from the adhesive, etc., are discharged through the outer skin, the endocrine disruptors may enter a person's body both via respiration and through skin contact.

Thus, a method of heat-fusing the outer skin onto either side of the cushion material has been proposed. However, during the heat-fusing, the air remaining between the cushion material and the outer skin cannot be discharged, resulting in air pockets remaining between the outer skin and the cushion material in a finished mat product. This in turn may increase the rate of defects in the mat products, lowering the consumer's confidence and possibly degrading a product's appearance. Moreover, if a detached portion is stepped on, the air within may be moved about so that the area of the detached portion may grow even larger, exacerbating the problem above.

Also, since it is generally difficult to store and move a mat due to its large size, a folding mat has been proposed. As shown in FIGS. 1A and 1B, a folding mat may include a multiple number of unit outer skins 2 connected to fold in a zigzag fashion, where each unit outer skin 2 holds a unit cushion mat 1 that is shaped as a broad rectangular block with relatively wide upper and lower surfaces. Here, the unit outer skins 2 may be connected by way of strip-like connector pieces 4 that are independent of the unit outer skins 2, while zippers 3 for inserting and withdrawing the unit cushion mats 1 may be formed in the sides of the unit outer skins 2.

However, this type of folding mat based on the related art may require attaching both sides (along the widthwise direction) of the relatively narrow connector pieces 4 to the respective unit outer skins 2. Such a complicated process, not to mention the inclusion of an additional process itself, may lower productivity and hurt cost competitiveness.

### PRIOR ART DISCLOSURE

Korean Patent Laid-Open No. 10-2014-0102916

### SUMMARY OF THE INVENTION

To resolve the problems described above, an aspect of the invention aims to provide a safety cushion mat and a mold for manufacturing the safety cushion mat, where the safety cushion mat is made to be environmentally friendly in that it does not discharge substances that are toxic to the human body, such as endocrine disruptors, because its several layers are not attached with adhesive. Another aim is to prevent the occurrence of the sheet being detached by air remaining in the filler material, so that the quality of the product and the consumers' level of confidence toward the product may be improved. Another aim is to allow the safety cushion mat to be readily perceived even during nighttime, thus providing for various usages such as in the context of children playrooms, camp sites, etc. Another aim is to allow easy movement by a wheelchair over the safety cushion mat without getting caught on the safety cushion mat, in which case the safety cushion mat would be particularly useful in a medical context. Another aim is to provide a safety cushion mat that can be folded to occupy a smaller volume for easier storage and transport, where the folding portions are not visible from above and where the folding portions are protected from foreign substances entering. This would provide a pleasing appearance, improved hygiene, and also greater safety, as it prevents wheelchairs from getting caught on the safety cushion mat.

According to a feature of the invention, a safety cushion mat may be provided that includes an inner filler 10 made of a synthetic resin expanded foam member, and a first sheet 20 and a second sheet 30 which cover an upper surface and a lower surface of the inner filler 10, respectively. The inner filler 10 may have air outlets 11 formed in its upper surface and lower surface, with the air outlets 11 formed in a particular pattern. The first sheet 20 may include a first sheet body portion 21 and a first edge portion 22, where the first sheet body portion 21 may be molded from synthetic resin and heat-fused onto the upper surface of the inner filler 10, while the first edge portion 22 may protrude from a boundary of the first sheet body portion 21 as an integrated part towards an outward direction of the inner filler 10. The second sheet 30 may include a second sheet body portion 31 and a second edge portion 32, where the second sheet body portion 31 may be molded from synthetic resin and heat-fused onto the lower surface of the inner filler 10, while the second edge portion 32 may protrude from a boundary of the second sheet body portion 31 as an integrated part towards an outward direction of the inner filler 10 and may be fused with the first edge portion 22 of the first sheet 20. When the first sheet 20 and the second sheet 30 are fused onto both sides of the inner filler 10, any air remaining between the first and second sheets 20, 30 and the inner filler 10 may be discharged through the air outlets 11 of the inner filler 10.

According to another feature of the invention, a safety cushion mat may be provided, in which an inclined part 12 that inclines downward towards the outer end is formed at a boundary of the upper surface of the inner filler 10.

According to still another feature of the invention, a safety cushion mat may be provided, where a phosphorescent coating layer 23 is formed on a boundary of the first sheet 20, with the phosphorescent coating layer 23 including a phosphorescent substance that is painted or laminated on to be perceivable during nighttime.

According to another feature of the invention, a safety cushion mat may be provided, in which a middle portion of the inner filler 10 is cut vertically to form a first and a second inner filler 10a, 10b on the left and right sides, and in which a fold part 33 is formed in a middle portion of the second sheet 30, where fold part 33 may be fused to a middle portion of the first sheet 20 so that the first and second inner fillers 10a, 10b may be folded and stacked one over the other.

According to another feature of the invention, a manufacturing mold for manufacturing a safety cushion mat may be provided, for a safety cushion mat that includes a first and a second inner filler 10 arranged in a row, where the first and second inner fillers 10 are shaped as quadrilateral blocks and have air outlets 11 formed in the upper surfaces and lower surfaces, and where the safety cushion mat is configured such that the first and second inner fillers 10 can be folded one over the other by way of a first and a second sheet 20, 30. The mold for manufacturing this safety cushion mat may include a lower mold 40 and an upper mold 50. The lower mold 40 may have two cavities formed in its upper side for receiving the first and second inner fillers 10a, 10b that are inserted therein or may have a partition 41 formed on its upper side for receiving the first and second inner fillers 10a, 10b that are disposed therein with a gap separating each other, and the lower mold 40 may also have vacuum suction paths 42 formed therein for applying vacuum suction, so that the second sheet 30 placed on an upper surface of the lower mold 40 may be kept in tight contact with an inner wall of the cavity or with the surface and the partition 10 by way of the vacuum suction. The upper mold 50 may mate with the lower mold 40 and may be configured to fuse together the overlapping portions of the second sheet 30, which may be positioned on a periphery part of the cavity or positioned on an upper surface of the partition 41, and the first sheet 30, which may be placed on an upper surface of the first and second inner fillers 10a, 10b.

According to an embodiment of the present invention, a cushion mat 1 can be provided in which the first and second sheets 20, 30 are attached by thermal fusion or high-frequency fusion, without using adhesive, each onto either side of the inner filler 2. As there is no discharge of toxic substances, the cushion mat is environmentally friendly and particularly suitable for medical facilities or use by children. Also, when the first and second sheets 20, 30 are attached to both sides of the inner filler 10, any residual air may be discharged through the air outlets 11 formed in both sides of the inner filler 10, allowing improved heat-sealing efficiency between the first and second sheets 20, 30 and the inner filler 10, and thereby improving the quality of the product and increasing product reliability. Since the first and second sheets 20, 30 thus may not become detached from the inner filler 10, a beautiful appearance can be maintained. Also, the problem of air moving about when a detached portion is stepped on and causing adjacent portions to become detached, so that the area of the detached portion grows ever larger, can be avoided.

An inclined part 12, which inclines downward from the upper surface at the outer end of the inner filler 10, can provide improved safety, as it helps prevents accidents caused by persons tripping and falling, and can provide improved convenience, as it allows wheelchairs to easily pass over the cushion mat 1 when used in a hospital.

Furthermore, a phosphorescent coating layer 23 formed on the upper surface of the cushion mat 1 can also help prevent accidents involving a person bumping a foot into or tripping on the cushion mat 1, since it allows the cushion mat 1 to be easily perceived during nighttime. In particular, when considering use in a medical context, a physically weakened patient may be badly hurt if the patient trips on a cushion mat 1 at night, but with a cushion mat 1 based on an embodiment of the invention, this risk can be avoided.

With the inner filler 10 formed as a first and a second inner filler 10a, 10b arranged side by side, and with a fold part 33 where a middle portion of the second sheet 30 is fused to a middle portion of the first sheet 20, the cushion mat can be folded such that the first and second inner fillers 10a, 10b are stacked one over the other, so that the space occupied by the cushion mat can be reduced for easier transport and storage. In addition, since the fold part 33 is not visible at the upper surface of the cushion mat 1, a more pleasing appearance can be achieved, and since there are no gaps in which foreign substances may gather or in which the wheel of a wheelchair may get caught, the cushion mat 1 can be used safely and conveniently especially in a medical context.

Moreover, the cushion mat 1, having the form of a first and a second inner filler 10a, 10b that are stackable one over the other, can be manufactured with a single process by way of a lower mold 40, in which cavities or a partition 41 is formed to hold the first and second inner fillers 10a, 10b in a separated state, and in which vacuum suction paths 42 are formed to keep the second sheet 30 in tight contact, and an upper mold 50, which mates with this lower mold 40 to fuse the overlapping portions of the first and second sheets 20, 30 at the partition 41. Thus, the manufacturing process does not require an operation of connecting the first and second sheets with connector pieces as in the related art, and the increased convenience of the manufacturing and the reduced number of processes involved can lead to improvements in productivity.

Additional aspects and advantages of the present invention will be set forth in part in the description which follows, and in part will be obvious from the description, or may be learned by practice of the invention.

### BRIEF DESCRIPTION OF THE DRAWINGS

FIG. 1A and FIG. 1B illustrate an example of a conventional mat.

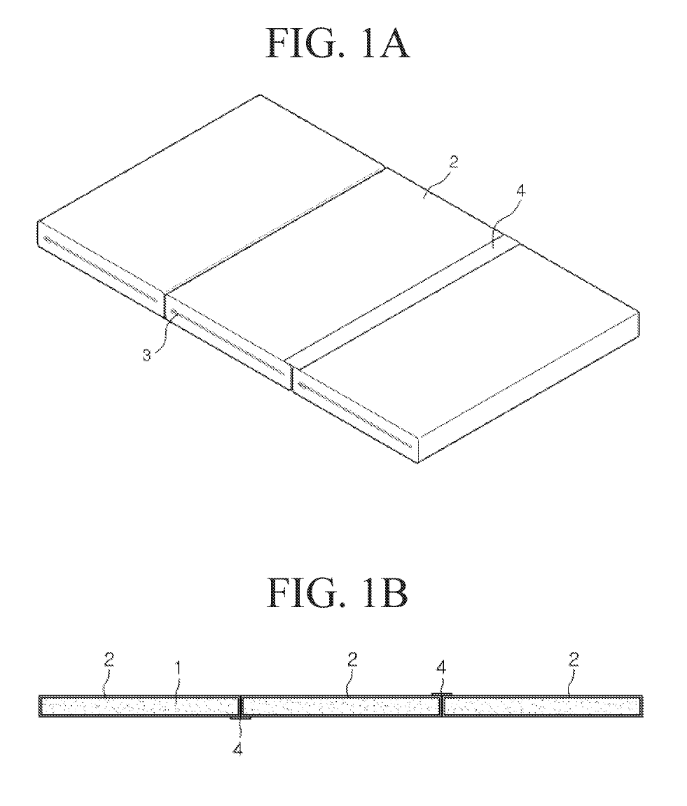

FIG. 2 is a perspective view of a safety cushion mat according to an embodiment of the invention.

FIG. 3 is an exploded perspective view of the safety cushion mat shown in FIG. 2.

FIG. 4 is a cross-sectional view across line A-A in FIG. 2.

FIG. 5A and FIG. 5B schematically illustrate a procedure for manufacturing the safety cushion mat shown in FIG. 2.

FIG. 6A and FIG. 6B are a perspective view and a cross-sectional view of a safety cushion mat according to another embodiment of the invention.

FIG. 7 is a flow diagram illustrating a procedure for manufacturing the safety cushion mat shown in FIG. 6A and FIG. 6B.

### DETAILED DESCRIPTION OF THE INVENTION

The objectives, characteristics, and advantages of the present invention mentioned above will become more clearly understood from the detailed descriptions provided below. Certain embodiments of the invention are described below with reference to the accompanying drawings.

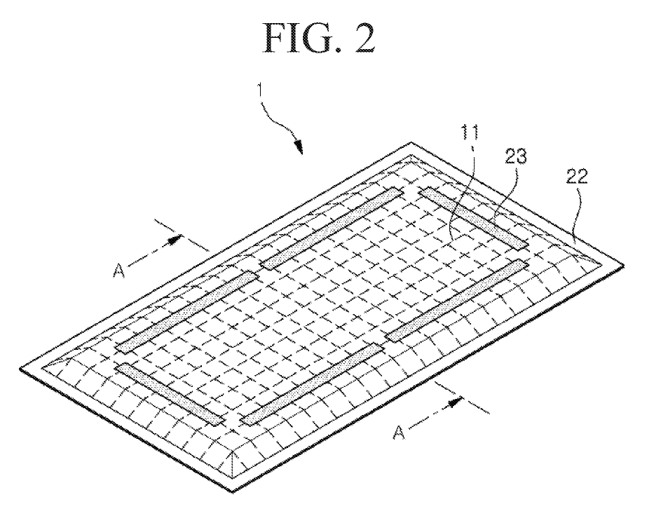

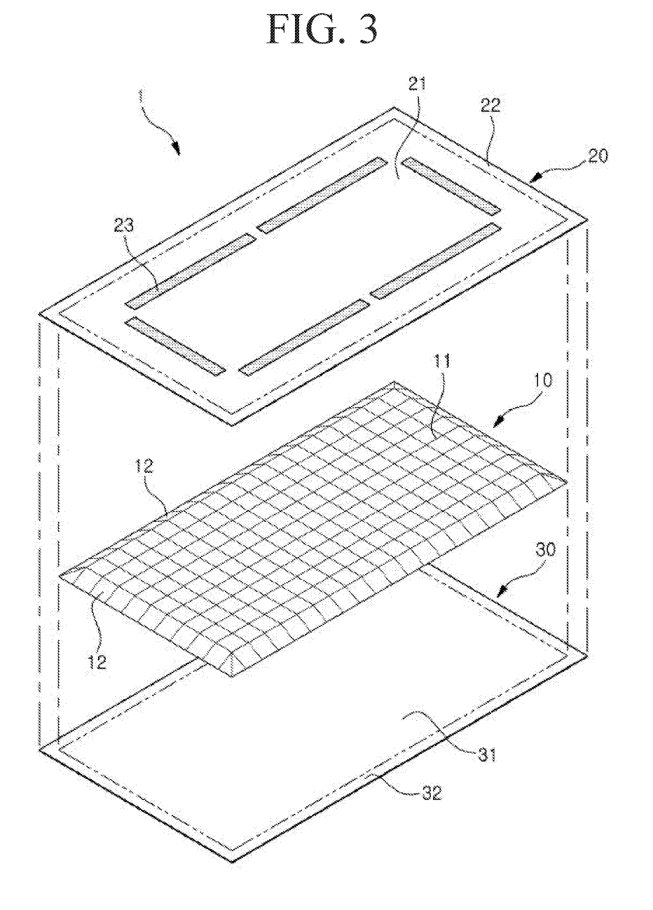

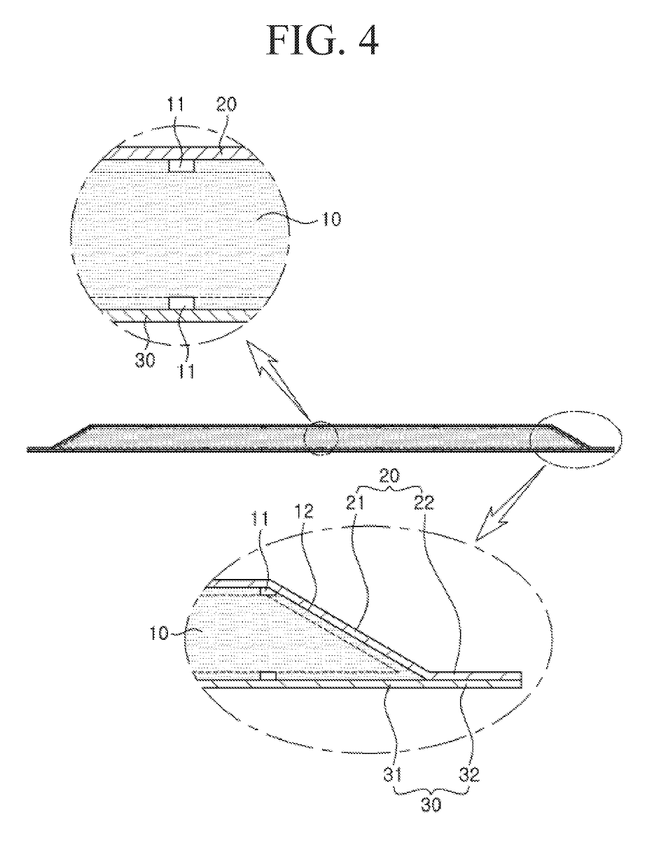

FIG. 2 through FIG. 5B illustrate a safety cushion mat according to an embodiment of the present invention. As shown in the drawings, a safety cushion mat 1 according to an embodiment of the invention may include an inner filler 10, and a first sheet 20 and a second sheet 30 that cover the upper surface and lower surface of the inner filler 10, respectively.

The inner filler 10 may be made as a synthetic resin expanded foam member of a particular thickness, preferably from a polyethylene expanded foam that is known as an environment-friendly material, unlike PVC which produces endocrine disruptors. The inner filler 10 may have air outlets 11 formed in its upper and lower surfaces according to a particular pattern. Here, an air outlet 11 may be formed as a groove having a generally “U” shaped cross section. Also, at the boundary of the upper surface of the inner filler 10, an inclined part 12 may be formed that inclines downwards toward an outer end, and the air outlets 11 may extend into the inclined part 12 as well.

Such inner filler 10 may be formed by expansion foam molding using a mold that is not shown. A protrusion part shaped as a particular pattern may be formed on the inside of the mold, so that the air outlets 11 having the particular pattern as above may be formed as a result of the expansion foam molding. While the illustrated example shows air outlets 11 implemented in a grid-like form, the present invention is not limited thus. Various types of patterns formed as combinations of lines, curves, etc., for example, can be used.

The first sheet 20 may be molded using synthetic resin to a size somewhat larger than that of the inner filler 10, and may include a first sheet body portion 21 and a first edge portion 22. The first sheet body portion 21 may be attached to an upper surface of the inner filler 10 by a known heat fusion method. The first edge portion 22 may be formed as an integrated body with the first sheet body portion 21 but protruding more outward at the outer end of the inner filler 10.

A phosphorescent coating layer 23 may be formed at the boundary of the first sheet 20 to be perceivable during nighttime, the phosphorescent coating layer 23 formed by painting or laminating a phosphorescent substance. Such a phosphorescent coating layer 23 can be formed along the boundary of the first sheet 20. While the illustrated example shows the phosphorescent coating layer 23 in the form of intermittent multiple lines, the present invention is not limited thus. The phosphorescent coating layer 23 can be implemented in various forms, for example as a continuous line, dots, etc.

The second sheet 30, similar to the first sheet 20, may be molded using synthetic resin to a size somewhat larger than that of the inner filler 10, and may include a second sheet body portion 31 and a second edge portion 32. The second sheet body portion 31 may be attached to a lower surface of the inner filler 10 by heat fusion. The second edge portion 32 may be formed as an integrated body with the second sheet body portion 31 but protruding more outward at the outer end of the inner filler 10, and may be fused to the first edge portion 22 of the first sheet 20 by heat fusion or high-frequency fusion.

A protrusion can be formed on the first edge portion 22 due to air outlet paths (not shown) formed in the molds 40, 50 for discharging any air remaining between the molds and the first edge portion 22 of the first sheet 20 when fusing the first edge portion 22 of the first sheet 20 and the second edge portion 32 of the second sheet 30 together. The first sheet 20 and the second sheet 30 may preferably be molded from polyethylene, an environmentally friendly material. The first and second sheets 20, 30 may be heat-fused onto both sides of the inner filler 10, where this heat fusion can in some cases include fusion based on generating heat via high-frequency waves.

A safety cushion mat 1 according to an embodiment of the invention having the composition described above may first have the inner filler 10 formed by expansion foam molding, with air outlets 11 formed as above. The first sheet 20 and the second sheet 30 may be molded, where the surfaces can be embossed to prevent slipping. Using a known heat fusion method, the second sheet 30 may be fused onto a surface of the inner filler 10 thus manufactured.

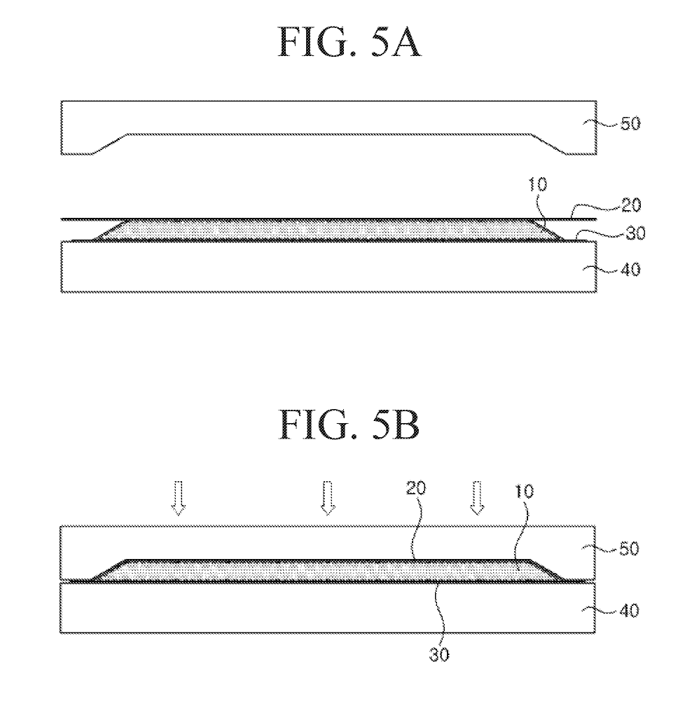

Afterwards, the inner filler 10 to which the second sheet 30 has been attached may be placed on a lower mold 40 as in FIG. 5A, and heat fusion may be applied by way of an upper mold 50 that has inclined surfaces formed at the boundaries. Here, when the upper mold 50 mates with the lower mold 40 as in FIG. 5B, there may be air remaining between the first sheet 20 and the inner filler 10. The residual air may be discharged towards the exterior of the inner filler 10 via the air outlets 11 of the inner filler 10. As a result, the problem of the first sheet 20 becoming detached from the inner filler 10 due to air remaining between the first sheet 20 and the inner filler 10 can be avoided. Likewise, when fusing the second sheet 30 onto the inner filler 10, air remaining between the second sheet 30 and the inner filler 10 may be discharged towards the exterior, so that the second sheet 30 may not have any part becoming detached from the inner filler 10, either.

With a safety cushion mat 1 according to an embodiment of the invention manufactured as above, the first and second sheets 20, 30 may be kept in complete airtight contact on either side of the inner filler 10 without adhesive, and since there is thus no discharge of toxic substances, the safety cushion mat 1 is environmentally friendly and is particularly suitable for use by patients or children. Also, since the occurrence of residual air causing the first and second sheets 20, 30 to become detached from the inner filler 10 can be prevented, the quality and reliability of the product may be improved. Such a cushion mat 1 can be installed beside a hospital bed, etc., for example, to protect the patient by cushioning falls without subjecting the patient, who may already have lowered immunity, to illnesses caused by a discharging of toxic substances.

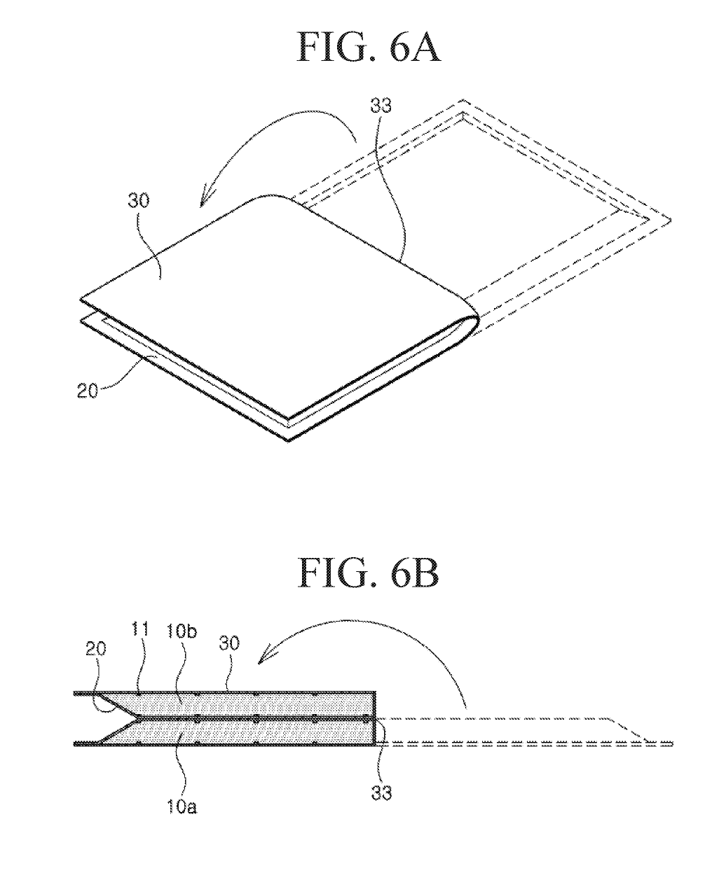

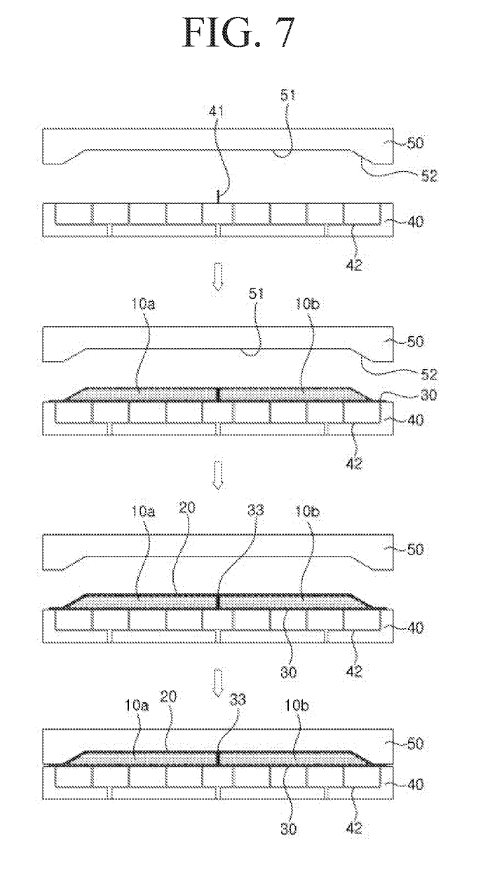

FIG. 6A, FIG. 6B, and FIG. 7 illustrate a safety cushion mat 1 and a mold for manufacturing this cushion mat 1 according to another embodiment of the invention. Such manufacturing mold may include an upper mold 50 and a lower mold 40. The inner filler 10 of the cushion mat 1 may formed to include a first and a second inner filler 10a, 10b and may have an inclined part 12 formed therein, but the inclined part may not be formed in parts where there is surface contact.

The lower mold 40 may have a partition 41 erected on an upper side thereof, or in some cases the lower mold 40 may have two cavities formed in the upper side. Thus, the two first and second inner fillers 10 may be disposed in a row front and back or left and right, separated by a gap in-between. In such lower mold 40, vacuum suction paths 42 may be installed in and connected with the upper side or the cavities. Accordingly, the second sheet 30 placed on the upper side of the lower mold 40 may be vacuum suctioned to be in tight contact with the upper side and partition 41 or with the cavities. Here, the lower mold 40 can also be equipped with a separate heating means designed to apply heat to the second sheet 30, and the second sheet 30 upon being heated can be made more flexible and can be placed in even tighter contact with the upper side of the lower mold 40.

The upper mold 50 may mate with the upper side of the lower mold 40, on which the second sheet 30, first and second inner fillers 10, and first sheet 20 have been stacked sequentially. Here, in the lower side of the upper mold 50, a cavity 51 may be formed in which the stack of the second sheet 30, first and second inner fillers 10, and first sheet 20 may be received. Along the boundary of this cavity 51, a cavity slope 52 may be formed so that the inclined part 12 of the first and second inner fillers 10 may be placed in tight contact therewith. Of course, in some embodiments, the upper mold 50 may not have a cavity slope 52, in which case the mat can be manufactured using first and second inner fillers 10a, 10b that do not have inclined parts 12 formed thereon.

A description is provided below, with reference to FIG. 7, of a procedure for manufacturing a folding safety cushion mat 1 using a lower mold 40 and an upper mold 50 such as those described above.

First, the second sheet 30 having the form of a film may be vacuum suctioned onto the lower mold 40 having the partition 41 formed on its upper side, in such a way that the second sheet 30 extends over the partition 41. Also, the first and second inner fillers 10a, 10b may be disposed with the partition 41 in-between, and the first sheet 20 may be disposed to cover the first and second inner fillers 10a, 10b. Then, the first and second sheets 20, 30 may be heat-fused in tight contact with the outer surfaces of the first and second inner fillers 10a, 10b. Here, the portion of the second sheet 30 that is disposed on the partition 41 of the lower mold 40 and the overlapping portion of the first sheet 20 may be fused together with heat or high-frequency waves, forming a fold part 33. As shown in FIG. 6B, air outlets 11 may be formed in both sides of the first and second inner fillers 10a, 10b, so that when the upper and lower molds 50, 40 mate together to apply fusion, any air remaining between the first sheet 20 and the first and second inner fillers 10a, 10b and between the second sheet 30 and the first and second inner fillers 10a, 10b may be discharged through the air outlets 11 towards the exterior, as in the previously described embodiment. Since the cushion mat 1 can be folded about the fold part 33, as shown in FIGS. 6A and 6B, it is easier to store and transport the cushion mat 1. The manufacture can be completed in a single process without having to use separate connector pieces as in the related art, and such reduction in the manufacturing process can reduce labor costs and improve productivity, thus providing an advantage in cost competitiveness.

It is to be appreciated that the present invention described above is not to be limited by the embodiments set forth above or by the accompanying drawings. It should be apparent to those of ordinary skill in the field of art to which the present invention pertains that various substitutions, alterations, and modifications can be derived without departing from the technical spirit of the present invention.

What is claimed is:

1. A safety cushion mat comprising an inner filler made of a synthetic resin expanded foam member, and a first sheet and a second sheet respectively covering an upper surface and a lower surface of the inner filler, wherein:
the inner filler has air outlets formed in an upper surface and a lower surface thereof, the air outlets formed in a particular pattern,
the first sheet comprises a first sheet body portion and a first edge portion, the first sheet body portion molded from synthetic resin and heat-fused onto the upper surface of the inner filler, the first edge portion protruding from a boundary of the first sheet body portion as an integrated part towards an outward direction of the inner filler,
the second sheet comprises a second sheet body portion and a second edge portion, the second sheet body portion molded from synthetic resin and heat-fused onto the lower surface of the inner filler, the second edge portion protruding from a boundary of the second sheet body portion as an integrated part towards an outward direction of the inner filler and fused with the first edge portion of the first sheet, and
air remaining between the first and second sheets and the inner filler is discharged through the air outlets of the inner filler when the first sheet and the second sheet are fused onto both sides of the inner filler.

2. The safety cushion mat of claim 1, wherein the inner filler has a middle portion thereof cut vertically to form a first and a second inner filler on a left and a right side, and the second sheet has a fold part formed in a middle portion thereof, the fold part fused to a middle portion of the first sheet and configured to allow folding such that the first and second inner fillers are stacked one over the other.

3. The safety cushion mat of claim 1, wherein the inner filler has an inclined part formed at a boundary on the upper surface thereof, the inclined part downwardly inclined towards an outer end.

4. The safety cushion mat of claim 2, wherein the inner filler has an inclined part formed at a boundary on the upper surface thereof, the inclined part downwardly inclined towards an outer end.

5. The safety cushion mat of claim 1, wherein the first sheet has a phosphorescent coating layer formed on a boundary thereof, the phosphorescent coating layer comprising a painted or laminated phosphorescent substance to be perceivable during nighttime.

6. The safety cushion mat of claim 2, wherein the first sheet has a phosphorescent coating layer formed on a boundary thereof, the phosphorescent coating layer comprising a painted or laminated phosphorescent substance to be perceivable during nighttime.

7. A manufacturing mold for manufacturing a safety cushion mat, the safety cushion mat comprising a first and a second inner filler arranged in a row, the first and second inner fillers each shaped as a quadrilateral block and having air outlets formed in an upper surface and a lower surface thereof, the safety cushion mat configured such that the first and second inner fillers are able to fold one over the other by way of a first and a second sheet, the manufacturing mold comprising:
a lower mold having two cavities formed in an upper side thereof for receiving the first and second inner fillers inserted therein or having a partition formed on an upper side thereof for receiving the first and second inner fillers disposed therein such that the first and second inner fillers are in a separated state, the lower mold having vacuum suction paths formed therein for applying vacuum suction, wherein the second sheet placed on an upper surface of the lower mold is kept in tight contact with an inner wall of the cavity or with the surface and the partition by way of the vacuum suction; and
an upper mold mating with the lower mold, the upper mold configured to fuse together overlapping portions of the second sheet positioned on a periphery part of the cavity or positioned on an upper surface of the partition and the first sheet placed on an upper surface of the first and second inner fillers.
